(19) United States
(12) Patent Application Publication
(10) Pub. No.: US 2006/0114969 A1
(43) Pub. Date: Jun. 1, 2006

(54) Data transmission device using SAW filters

(75) Inventors: Kyu Hwan Ahn, Seoul (KR); Jong In Na, Seoul (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Samsung Electro-Mechanics Co., Ltd., Suwon (KR)

(21) Appl. No.: 11/069,244

(22) Filed: Mar. 1, 2005

(30) Foreign Application Priority Data
Nov. 29, 2004 (KR) 10-2004-98902

(51) Int. Cl. H04B 1/69

(52) U.S. Cl. 375/139

(57) ABSTRACT

A data transmission device is implemented using SAW filters, passive elements. The transmission device includes a controller that receives transmission data, checks the state of every two bits thereof, and controls the input path of a pulse signal according to the checked state; a switching unit that includes selective output terminals and performs switching under control of the controller to output a received pulse signal to one of the output terminals; and a SAW filter array that includes SAW filters, which receive pulse signals respectively from the output terminals and demodulate the pulse signals respectively into analog signals having different frequency characteristics.

### RELATED APPLICATION

The present application is based on, and claims priority from, Korean Application Number 2004-98902, filed Nov. 29, 2004, the disclosure of which is incorporated by reference herein in its entirety.

### BACKGROUND OF THE INVENTION

1. Field of the Invention

The present invention relates to a wireless transmitter and receiver for data communication through wireless signals, and more particularly to a data transmission device, which is implemented using Surface Acoustic Wave (SAW) filters, which are passive elements, instead of using active elements whose power consumption is high, so as to minimize power consumption, and which also allows the receiving side to receive and demodulate signals transmitted from the transmission device through FM demodulation.

2. Description of the Related Art

As a sensor network standard such as Zigbee and portable communication have been proposed, much attention has been given to communication devices, which are wirelessly connected and are driven by batteries.

Zigbee is a wireless network standard for data communication and home automation based on 2.4 GHz, which features low power consumption, low cost, and low speed. The standardization of Zigbee has been in progress in IEEE 802.15.4. Zigbee uses dual PHY with frequency bands 2.4 GHz and 868/915 MHz, and uses Direct Secure Spread Spectrum (DSSS) modulation and demodulation. Zigbee can be used to implement a large-scale wireless sensor network for transmitting data at rates of 20 to 250 kbps within a 30-meter radius. Zigbee allows more convenient use of home automation that enables lamp control, home security, switching on and off of home appliances, etc., using a button from any location in the home.

High performance and low power design of communication equipment is essential to guarantee a long communication time in such a network.

FIG. 1 is block diagram of a conventional wireless data transmitter and receiver based on Frequency Modulation (FM) generally used in communication equipment, respectively.

As shown in FIG. 1(a), the conventional transmitter includes a Digital to Analog Converter (DAC) 11, a Phase Locked Loop (PLL) 12, a Voltage Controlled Oscillator (VCO) 13, a Power Amplifier (PAM) 14, and an antenna. The DAC 11 converts transmission data to an analog signal. The converted analog signal of the transmission data is provided to the PLL 12 to control the oscillation frequency of the VCO 13.

FM is a modulation technique in which transmission data is carried by a frequency varying according to the bit state of the transmission data. The PLL 12 and the VCO 13 FM-modulate the transmission signal to convert it to a corresponding frequency signal.

The FM-modulated transmission signal output from the VCO 13 is amplified to a transmission power through the PAM 14, and is then provided to the antenna.

As shown in FIG. 1(b), the conventional receiver includes a Band Pass Filter (BPF) 14, a Low Noise Amplifier (LNA) 16, a frequency detector 17, a Low Pass Filter (LPF) 18, an Analog to Digital Converter (ADC) 19, and an antenna. A wireless signal of a selected radio channel received through the antenna is first passed through the BPF 15 to filter out other channel signals or noise. The received signal is then low-noise-amplified through the LNA 16.

The frequency of the received signal is detected through the frequency detector 17, and the resulting signal is passed through the LPF 18 to filter out noise. The received signal is then converted to digital data composed of a sequence of bits “0” and “1” through the ADC 19.

In the conventional data transmitter and receiver, guarantee of the coincidence between the received data and the transmission data depends on both distortion of the wireless signal received over the radio channel, which is caused in the reception procedure, and the accuracy of the frequency detection in the frequency detector 17.

Transmitters used in most communication equipment, as well as the conventional FM transmitter described above, are basically composed of active elements such as PLL and VCO. In order to be activated, the active elements must be supplied with a minimum power level or greater, so that the active elements consume a certain level of power or more even when employing a power saving mode in which power is supplied only when in use.

In particular, low power design is essential to allow semi-permanent use of communication equipment in Zigbee wireless networks. However, the conventional transmitter and receiver have limitations on low power design due to the active elements.

Thus, there is a need to provide a new transmitter and receiver that minimizes the use of the active elements that inherently have high power consumption, and enables implementation of lower power, high performance communication equipment.

### SUMMARY OF THE INVENTION

Therefore, the present invention has been made in view of the above problems, and it is an object of the present invention to provide a data transmission device, which is implemented using Surface Acoustic Wave (SAW) filters, which are passive elements, instead of using active elements whose power consumption is high, so as to minimize power consumption, and which also allows the receiving side to receive and demodulate signals transmitted from the transmission device through FM demodulation.

In accordance with the present invention, the above and other objects can be accomplished by the provision of a data transmission device using Surface Acoustic Wave (SAW) filters, the device comprising: a controller for receiving transmission data, checking a state of every two bits of the transmission data, and controlling an input path of a pulse signal according to the checked two-bit state; a switching unit including a plurality of selective output terminals and performing a switching operation under control of the controller to output a pulse signal input to the switching unit to one of the plurality of selective output terminals; and a SAW filter array including a plurality of SAW filters receiving pulse signals respectively from the selective output terminals of the switching unit and demodulating the received pulse signals respectively into analog signals having different frequency characteristics, thereby outputting analog signals corresponding respectively to four two-bit states of the transmission data.

Preferably, the SAW filter array comprises a first SAW filter for receiving a pulse signal via the switching unit and outputting a signal having a low frequency from among frequency signals included in the received pulse signal; a second SAW filter for receiving a pulse signal via the switching unit and outputting a frequency-shifted signal whose frequency varies from the low frequency to a high frequency with time, the low and high frequencies included in a frequency band of frequency signals included in the received pulse signal; a third SAW filter for receiving a pulse signal via the switching unit and outputting a frequency-shifted signal whose frequency varies from the high frequency to the low frequency with time; and a fourth SAW filter for receiving a pulse signal via the switching unit and outputting a signal having the high frequency from among frequency signals included in the received pulse signal.

Preferably, the pulse signal input to the SAW filter array is a pulse signal whose amplitude is kept constant during a period of the pulse signal, which is generated at intervals of a predetermined period. Preferably, the controller controls the switching operation according to a two-bit state of transmission data received according to a period of the pulse signal. Preferably, the SAW filter array outputs a frequency signal maintained during a period of a received pulse signal.

The data transmission device according to the present invention can transmit data by converting each two bits of the data to an analog signal in a form similar to an FM modulated signal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is block diagrams of a conventional data transmission and reception device;

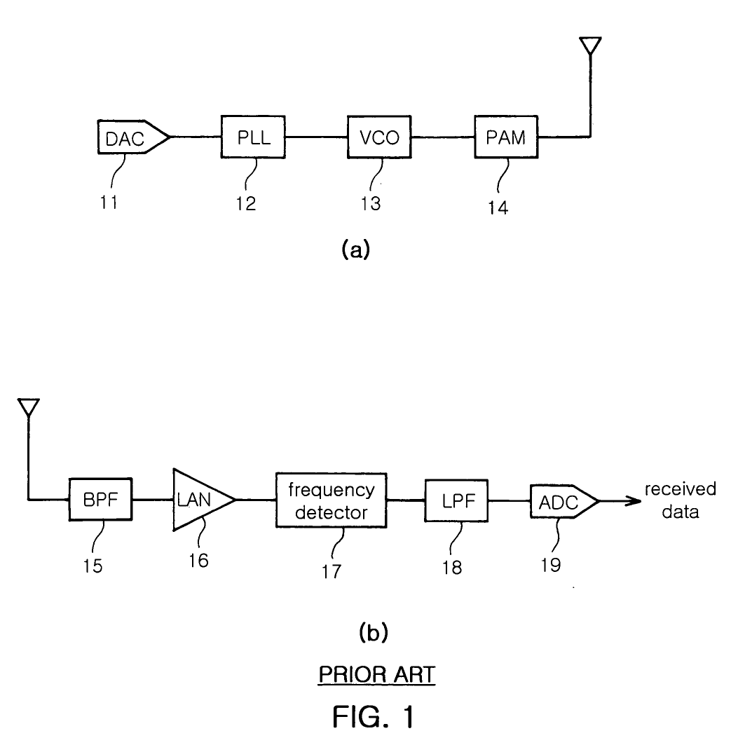

FIG. 2 is a schematic diagram illustrating an example use of chirp modulation in a communication system;

FIG. 3 is illustrating how up-chirp/down-chirp SAW filters operate;

FIG. 4 is a block diagram of a data transmission device according to the present invention using SAW filters; and

FIGS. 5 is illustrating a detailed structure of a SAW filter array in the data transmission device according to the present invention.

### DESCRIPTION OF THE PREFERRED EMBODIMENTS

The configuration and operation of a data transmission device using SAW filters according to the present invention will now be described in detail with reference to the drawings.

The present invention uses chirp modulation in wireless communication of digital data.

The chirp modulation is a type of spread-spectrum modulation, in which the frequency of a signal is varied in a predetermined manner during one pulse period.

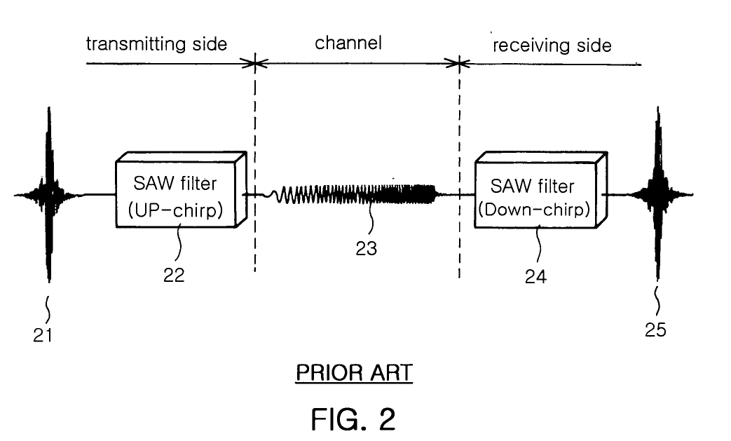

FIG. 2 is a schematic diagram illustrating a communication system using chirp modulation. If a one-period pulse signal 21 is input to an up-chirp SAW filter 22 on the transmitting side, the up-chirp SAW filter 22 modulates it into a chirp signal 23 by time-shifting a plurality of frequency signals included in the one-period pulse signal according to their frequencies. The chirp signal 23 is provided in such a form that high-frequency signals precede and low-frequency signals follow as shown in FIG. 2. If the chirp signal 23 is transmitted and input to a down-chirp SAW filter 24 on the receiving side, the down-chirp SAW filter 24 outputs the original pulse signal 25 by frequency-shifting the chirp signal 23 in a manner opposite to that of the up-chirp SAW filter 22 on the transmitting side.

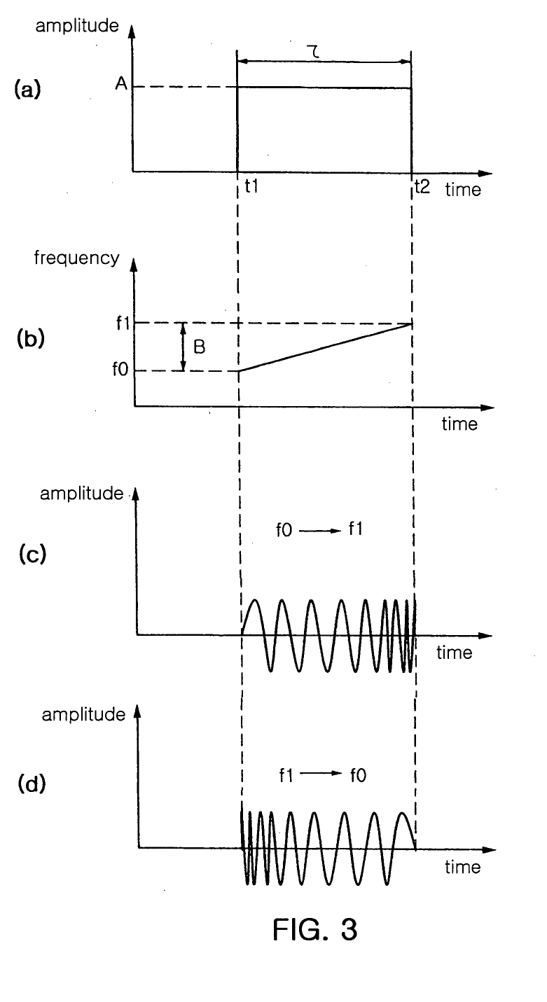

FIG. 3 is illustrating how the up and down-chirp SAW filters 22 and 24 operate. FIG. 3(a) shows a pulse signal whose amplitude “A” is kept constant during one pulse period “τ”, FIG. 3(b) shows a band of frequencies “B” shifted by the SAW filters 22 and 24, FIG. 3(c) shows the waveform of an output signal of the down-chirp SAW filter 24 when the pulse signal of FIG. 3(a) is input to the down-chirp SAW filter 24, and FIG. 3(d) shows the waveform of an output signal of the up-chirp SAW filter 22 when the pulse signal of FIG. 3(a) is input to the up-chirp SAW filter 22.

When receiving a pulse signal whose period is “τ” as shown in FIG. 3(a), the SAW filters 22 and 24 time-shift frequency signals in the pass band (f0˜f1) of the SAW filters 22 and 24, from among consecutive frequency signals included in the pulse signal, according to their frequencies, as shown in (c) and (d) of FIG. 3. The up-chirp SAW filter 22 operates to output an up-chirp signal whose frequency varies with time such that a high-frequency (f1) signal precedes and a low-frequency (f0) signal follows as shown in FIG. 3(d). The down-chirp SAW filter 24 operates to output a down-chirp signal whose frequency varies with time such that a low-frequency (f0) signal precedes and a high-frequency (f1) signal follows as shown in FIG. 3(c). When receiving the shifted frequency signals as shown in FIGS. 3(c) and (d), the up-chirp and down-chirp SAW filters 22 and 24 output a pulse signal as shown in FIG. 3(a) by gathering the shifted frequency signals in the same time interval in an opposite manner to the above mentioned manner.

Such a chirp modulation technique is used in radar-related devices such as radar altimeters and Synthetic Aperture Radars (SAR), and is also used in communication. When the chirp modulation technique is used in communication, communication is performed with an up-chirp signal defined as a mark and a down-chirp signal defined as a space, thereby providing a communication system robust against interference or interruption.

Using these chirp signals, the data transmission device according to the present invention can modulate and transmit digital data into an analog wireless signal by means of only the SAW filters, rather than using active elements such as mixers or PLLs, and the receiving side can receive and demodulate the transmitted analog wireless signal using a general FM receiver, without the need to use a specially designed receiver.

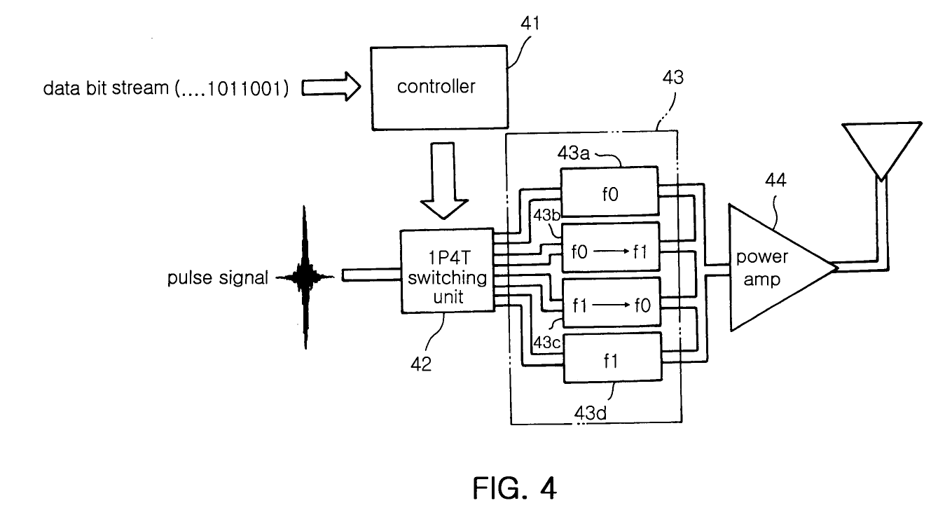

FIG. 4 is a detailed block diagram of a data transmission device according to the present invention.

The configuration and operation of the data transmission device according to the present invention will now be described in detail with reference to FIG. 4.

As shown in FIG. 4, the data transmission device according to the present invention includes a controller 41, a switching unit 42, a SAW filter array 43, and a power amplifier 44. The controller 41 receives a bit stream of data for transmission and divides the bit stream on a 2-bit basis, and controls a pulse signal to be input via one of four input paths according to the state of every 2 bits of the transmission data. The switching unit 42 performs a switching operation under the control of the controller 41 to output a pulse signal input thereto to one of its four selective output terminals. The SAW filter array 43 includes four SAW filters 43a, 43b, 43c, and 43d, which are connected respectively with the four selective output terminals of the switching portions 42 and output different frequency signals. The SAW filter array 43 converts the input pulse signal into one of four types of frequency signals, and outputs the converted frequency signal. The power amplifier 44 amplifies power of the frequency signal output from the SAW filter array 43, and transmits the amplified signal through an antenna.

When receiving a pulse signal via the switching unit 42, the first SAW filter 43a of the SAW filter array 43 passes a low-frequency (f0) signal among frequency signals included in the pulse signal. When receiving a pulse signal via the switching unit 42, the second SAW filter 43b outputs a frequency-shifted signal whose frequency varies from the low frequency f0 to the high frequency f1 with time, the low and high frequencies f0 and f1 being included in the frequency band of the frequency signals included in the pulse signal. When receiving a pulse signal via the switching unit 42, the third SAW filter 43c outputs a frequency-shifted signal whose frequency varies from the high frequency f1 to the low frequency f0 with time. When receiving a pulse signal via the switching unit 42, the fourth SAW filter 43d passes a high-frequency (f1) signal among the frequency signals included in the pulse signal.

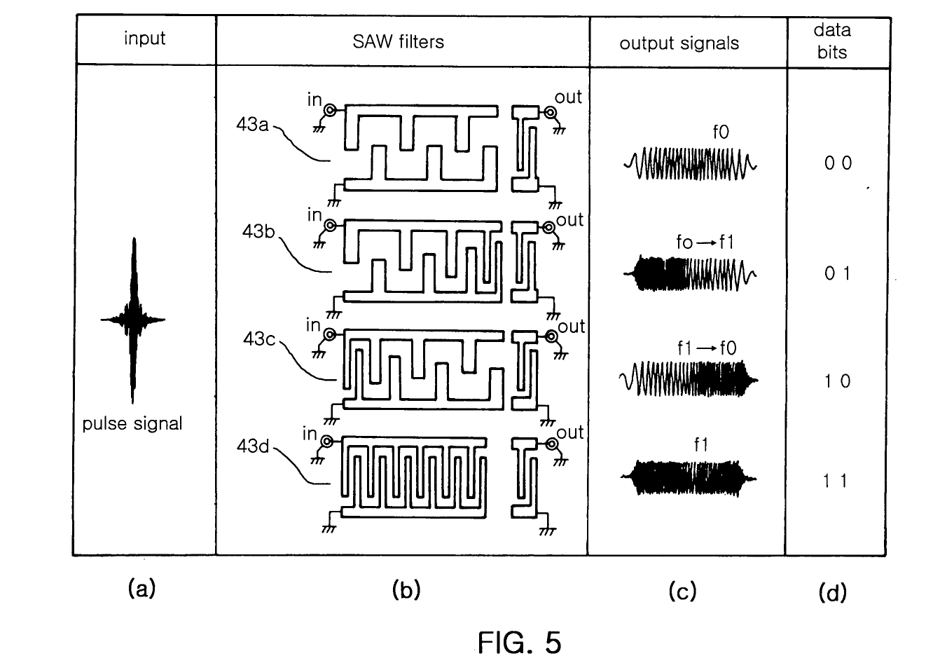

The first to fourth SAW filters 43a to 43d are configured as shown in FIG. 5. The first SAW filter 43a is implemented using an Interdigital Transducer (IDT), elements of which are arranged at uniform intervals in the surface acoustic wave propagation direction (i.e., in the direction from the input side to the output side), the intervals being relatively large as compared to the other SAW filters. The second SAW filter 43b is implemented using an IDT, elements of which are arranged at intervals decreasing in the surface acoustic wave propagation direction. The third SAW filter 43c is implemented using an IDT, elements of which are arranged at intervals increasing in the surface acoustic wave propagation direction. The fourth SAW filter 43d is implemented using an IDT, elements of which are arranged at uniform intervals in the surface acoustic wave propagation direction, the intervals being relatively small as compared to the other SAW filters.

FIG. 5 shows a generally known basic structure of each of the SAW filters 43a to 43d. The structure of each of the SAW filters 43a to 43d can be changed in actual implementation.

Using the SAW filters 43a to 43d, the data transmission device according to the present invention generates analog waveforms corresponding respectively to the four states of every 2 bits of data to be transmitted. The data transmission device performs data modulation similar to QPSK in this manner in order to perform data communication.

The data transmission device according to the present invention operates in the following manner.

First, a bit stream of data for transmission is input to the controller 41.

The controller 41 divides the transmission data bit stream on a 2-bit basis, and controls the switching operation of the switching unit 42 according to the state of every 2 bits of the transmission data so that a pulse signal input to the switching unit 42 is transferred to a corresponding one of the four SAW filters 43a to 43d in the SAW filter array 43.

Each time the controller 41 receives two bits of the transmission data bit stream, the switching unit 42 provides the pulse signal to a corresponding one of the four SAW filters 43a to 43d in the SAW filter array 43 under the control of the controller 41.

The one of the four SAW filters 43a to 43d, to which the pulse signal is provided via the switching unit 42, performs chirp modulation on the pulse signal.

The first to fourth SAW filters 43a to 43d are implemented as shown in (b) of FIG. 5, and output signals having different frequency characteristics as shown in FIG. 5 (c) when receiving a pulse signal as shown in FIG. 5(a).

The first SAW filter 43a outputs only a frequency signal having the low frequency f0 among frequency signals included in the input pulse signal during the pulse period “τ”. The second SAW filter 43b outputs a down-chirp signal whose frequency varies from the low frequency f0 to the high frequency f1 with time in the input pulse period “τ”. The third SAW filter 43c outputs an up-chirp signal whose frequency varies from the high frequency f1 to the low frequency f0 with time in the input pulse period “τ”. The fourth SAW filter 43d outputs only a frequency signal having the high frequency f1 during the pulse period “τ”.

The signals output from the first to fourth SAW filters 43a to 43d of the SAW filter array 43 are transmitted through the antenna after being amplified by the power amplifier 44.

The four two-bit states of the transmission data input to the controller 41 correspond respectively to four analog signals output from the four SAW filters 43a to 43d of the SAW filter array 43 as shown in FIG. 5.

In the example of FIG. 5, the first two-bit state “00” is set to correspond to an analog frequency signal having the low frequency f0, the second two-bit state “01” is set to correspond to an down-chirp signal whose frequency varies from the low frequency f0 to the high frequency f1 (f0→f1), the third two-bit state “01” is set to correspond to an up-chirp signal whose frequency varies from the high frequency f1 to the low frequency f0 (f1→f0), and the fourth two-bit state “11” is set to correspond to an analog frequency signal having the high frequency f1. If two bits of transmission data are input to the controller 41, the controller 41 and the switching unit 42 operate to allow the SAW filter array 43 to output an analog signal corresponding to the two-bit state of the transmission data.

When receiving a signal transmitted from the data transmission device according to the present invention, the receiving side can recover the original data bit stream from the received signal, provided that the relationship between the data bit states and the frequency signal types is known to the receiving side. Since the frequency of the wireless signal transmitted from the data transmission device according to the present invention varies depending on the bit state of data carried by the wireless signal, the receiving side can recover the original data bit stream simply using the existing FM demodulator without requiring a specially designed receiver unit.

In addition, the present invention can reduce power consumption in the transmitting side by replacing active elements such as mixers or PLLs with the SAW filters, and can also simplify the configuration of the transmitting side by converting transmission data directly to a wireless transmission signal without using a digital modem or a digital to analog converter.

As apparent from the above description, the present invention provides a data transmission device using Surface Acoustic Wave (SAW) filters that have the following advantages. It is possible to reduce the number of active elements used in the transmitting side in wireless communication equipment for data communication through wireless signals, thereby significantly reducing power consumption in the transmitting side. This allows design of low power communication equipment. Since the data transmission device according to the present invention implements Frequency Modulation (FM) using only the SAW filters rather than active elements, the receiving side can demodulate a wireless signal transmitted from the transmitting side into a data stream using a general FM demodulator, thereby increasing the flexibility in designing communication equipment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A data transmission device using. Surface Acoustic Wave (SAW) filters, the device comprising:
a controller for receiving transmission data, checking a state of every two bits of the transmission data, and controlling an input path of a pulse signal according to the checked two-bit state;
a switching unit including a plurality of selective output terminals and performing a switching operation under control of the controller to output the pulse signal to one of the plurality of selective output terminals; and
a SAW filter array including a plurality of SAW filters receiving pulse signals respectively from the selective output terminals of the switching unit and demodulating the received pulse signals respectively into analog signals having different frequency characteristics, thereby outputting analog signals corresponding respectively to four two-bit states of the transmission data.

2. The data transmission device according to claim 1, wherein the SAW filter array comprises:
a first SAW filter for receiving a pulse signal via the switching unit and outputting a signal having a low frequency from among frequency signals included in the received pulse signal;
a second SAW filter for receiving a pulse signal via the switching unit and outputting a frequency-shifted signal whose frequency varies from the low frequency to a high frequency with time, the low and high frequencies included in a frequency band of frequency signals included in the received pulse signal;
a third SAW filter for receiving a pulse signal via the switching unit and outputting a frequency-shifted signal whose frequency varies from the high frequency to the low frequency with time; and
a fourth SAW filter for receiving a pulse signal via the switching unit and outputting a signal having the high frequency from among frequency signals included in the received pulse signal.

3. The data transmission device according to claim 1, wherein the pulse signal input to the SAW filter array is a pulse signal whose amplitude is kept constant during a pulse period of the pulse signal.

4. The data transmission device according to claim 1, wherein the pulse signal is generated at intervals of a predetermined period.

5. The data transmission device according to claim 1, wherein the controller controls the switching operation according to a two-bit state of transmission data received according to a period of the pulse signal.

6. The data transmission device according to claim 1, further comprising a power amplifier for amplifying power of a frequency signal output from the SAW filter array and outputting the amplified signal through an antenna.

7. The data transmission device according to claim 2, wherein the second SAW filter is a down-chirp filter performing down-chirp modulation on a pulse signal.

8. The data transmission device according to claim 2, wherein the third SAW filter is an up-chirp filter performing up-chirp modulation on a pulse signal.

9. The data transmission device according to claim 3, wherein the SAW filter array outputs a frequency signal maintained during a period of a received pulse signal.
